(19) United States
(12) Patent Application Publication
(10) Pub. No.: US 2004/0252103 A1
(43) Pub. Date: Dec. 16, 2004

(54) Apparatus to support a device to control an electronic or computer system by means of a fluid flow and a method of manufacturing the same

(76) Inventor: Pierre Bonnat, Grieges (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/812,565

(22) Filed: Mar. 29, 2004

Related U.S. Application Data
(60) Provisional application No. 60/458,904, filed on Mar. 28, 2003.

(51) Int. Cl. G09G 5/00

(52) U.S. Cl. 345/156

(57) ABSTRACT

A device to provide input to a computer system, utilizing alternate means of input that do not require hands and limbs support. The device includes a flexible member that enables the device to wrap around objects of various shapes and sizes. In another aspect of the present invention, the device is designed to be wearable by a user, such as but not limited, to his neck area.

### RELATED APPLICATIONS

The present application is related to, incorporates by reference and hereby claims the priority benefit of the following U.S. Provisional Patent Application, assigned to the assignee of the present application:

i. U.S. Provisional Patent Application No. 60/458,904, filed Mar. 28, 2003, entitled “An Apparatus to Support a Device to Control an Electronic or Computer System by Means of a Fluid Flow and a Method of Manufacturing the Same.”

### FIELD OF THE INVENTION

An exemplary embodiment relates in general to controlling a computer system or an electronic system, and, more specifically, to a device to control an electronic or computer system by means of a fluid flow and a method of manufacturing the same.

### BACKGROUND

Input devices for entering commands into a computer or electronic system are currently available in a variety of forms and configurations. Many such input devices take the form of a keyboard, touchpads, mouse or trackball device. There is an increasing trend of reducing the size of the input devices and work space is reduced or not available. Consequently, it is harder to use such devices without causing stress on the user's fingers, wrist and forearm. Pointing device designers and manufacturers are continually attempting to design devices that are comfortable for the user to operate for long periods of time and reduce Repetitive Stress Injuries.

The U.S., Intelligent Transportation Systems and In-Vehicle Internet converge with phones, infotainment and GPS to turn vehicles, such as automobile and aerospace vehicles, into moving-communicating-spaces.

In relationship to this evolution, safe and easy navigation tools are useful to allow a natural usage of these resources. Also, for reasons of cost constraints and limited instrument panel space, motor vehicle manufacturers are looking towards more integrated driver information systems. So far, touch screens, trackballs, rocker switches have proved to be unsuitable for safety reasons. This is especially so when such input devices require the user to use his hands to operate the devices. Frequently, complex GUIs application is used for such input devices, which again is unsuitable for such environment.

With the convergence of technologies, many computer and electronic applications are increasingly more complex. Frequently, a user is required to perform multiple tasks at any one time. Therefore, hands-free pointing and navigation tool provides a means to provide multiple inputs. For example, in electronic music performance, a player may need to provide input to both the musical instruments and computer systems. And in most situations, several input devices, such as a keyboard and a mouse, are used. In another example, a maintenance engineer may probe circuit boards while navigating schematics. Hands-free device provides a convenient way for the user to provide input to the system.

In some exemplary situations, such as multimedia and gaming application, hands-free device may enhance a user's experience. For example, with the advent of so-called TVPCs, which is a fusion of PC centric and TV centric technologies, TV sets are operated through GUIs comparable to PCs. A hands-free device enables the user to input his control and command conveniently.

### SUMMARY OF THE INVENTION

According to one embodiment, there is provided a device to provide input to a computer system, the device including a first module having a sensor, a second module having a signal processing unit, and a flexible member connecting the first module and the second module, the flexible member being formable to secure the device to a support and having at least a portion of sufficient rigidity to support the first module in an input position to detect the input provided by the user.

According to another embodiment, there is provided a device to provide input to a computer system, the device including a first housing including at least one of a sensor and a signal processor, at least an arm coupled to and extendable relative to the housing so as to support the housing relative to a support and the arm being deformable and having at least a portion of sufficiently rigidity to support the sensor in an input position to detect the pressure current input provided by the user.

Other aspects and advantages of the invention will become apparent from the following detailed description in combination with the accompanying drawings, illustrating, by way of example, the principles of the invention.

### BRIEF DESCRIPTION OF THE DRAWINGS

FIG. 1a-b shows a freestanding design of the apparatus according to an exemplary embodiment.

FIG. 2 illustrates another exemplary embodiment suitable for a user to wear the apparatus around his neck.

FIG. 3 illustrates another exemplary embodiment wherein the apparatus wraps around an object.

FIG. 4a-d illustrates yet another exemplary embodiment wherein the user wears the apparatus around his neck.

FIG. 5 is a block diagram illustrating an exemplary method of manufacturing the apparatus.

### DETAILED DESCRIPTION

In one exemplary embodiment, the device provides ease of use where no hand or limb support is required to use the apparatus.

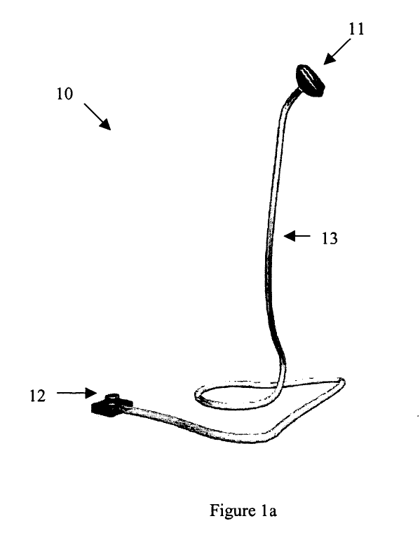

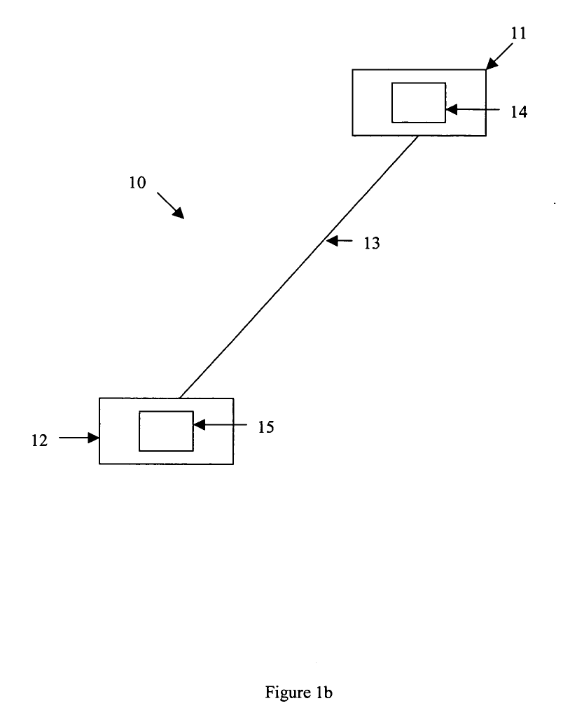

FIGS. 1a and 1b are pictorial representations of a flexible freestanding design of the device 10, according to the exemplary embodiments. The device 10 includes three primary parts, namely a first module 11 in the exemplary form of a sensor 14, a second module 12 in the exemplary form of a processing unit 15 and a flexible (or semi-flexible) arm 13. The first module 11 includes sensor 14, which may be surface-mounted/PCB, and may operationally be positioned in the proximity of the user's chin area. The sensor 14 of the first module 11 detects the flow of fluid provided by the user. The second module 12 includes a processing unit 15 to effectuate processing, power, and RF broadcasting in wireless environments such as Bluetooth. In a further exemplary embodiment, the processing unit 15 may be integrated into the first module 11. In this embodiment, the second module 12 is redundant or is used as a supporting base.

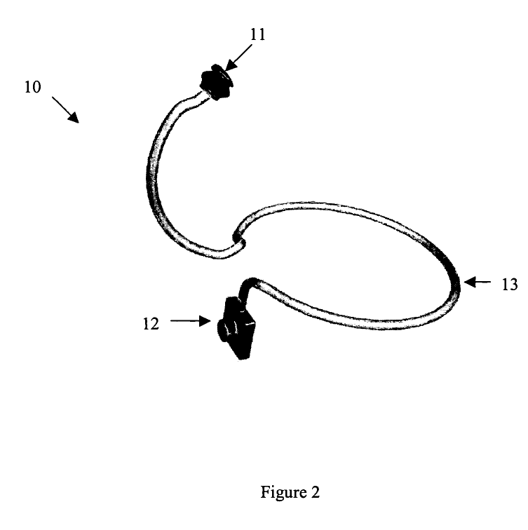

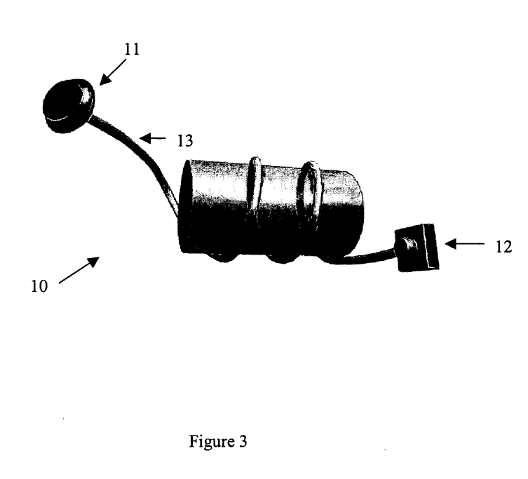

The arm 13 that connects the first module 11 and the second module 12 may be made of a semi-flexible material that makes it possible to form the device 10 into a shape or configuration, as illustrated in FIG. 2, suitable for wrapping the device 10 around the neck of user. It is also possible to wrap the device 10 around other parts of the user's body or around objects of various shapes and sizes, as illustrated in FIG. 3. It will be appreciated by one skilled in the art that the flexibility of the material of the arm 13 can be modified or chosen to suit a variety of applications. For example, the arm 13 may be designed to retain a certain shape for ease of wearing the device 10 around the neck of a user. Therefore, it may be required that the member 13 be made of material which is only partly flexible.

The arm 13 may house wiring that couples the first module 11 and the second module 12. The fluid flow generated by the user does not, in one embodiment, result in air circulation in the arm 13. In some embodiments, the device can be used as a gesture recognition system.

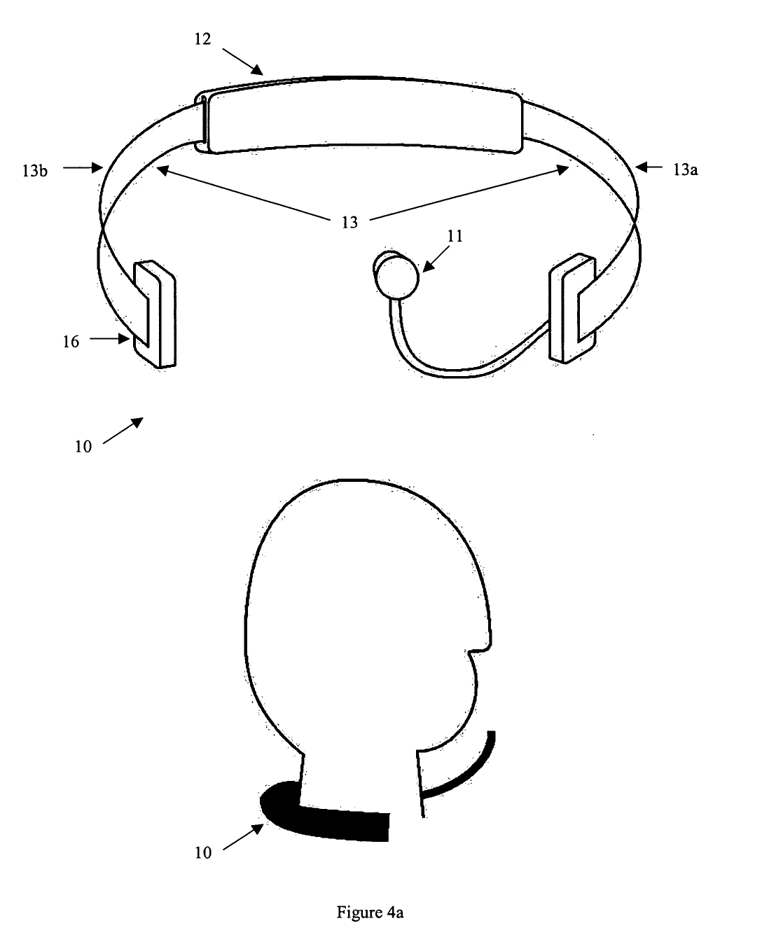

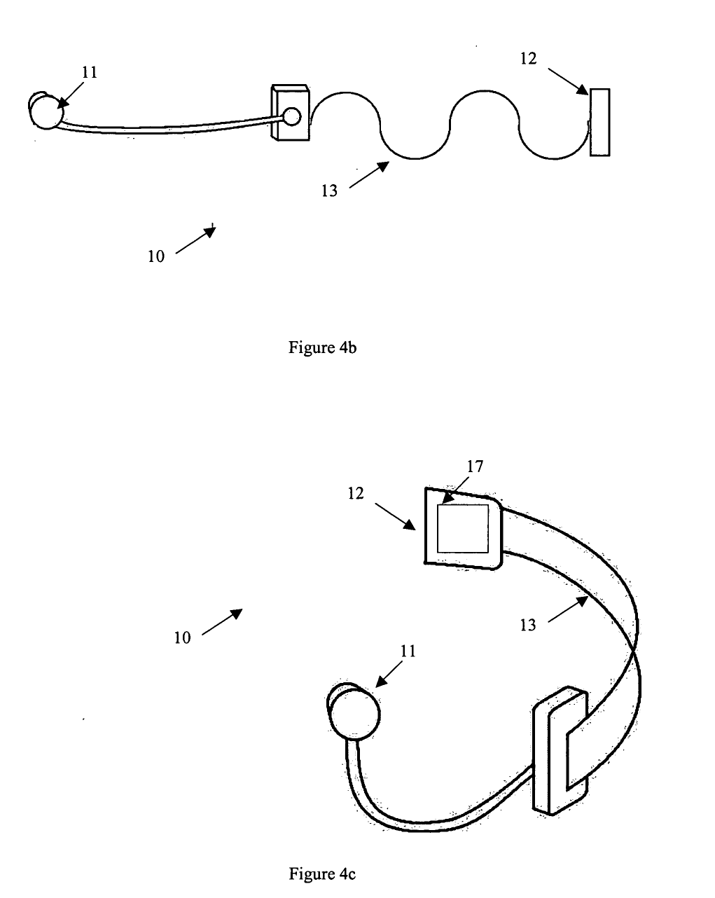

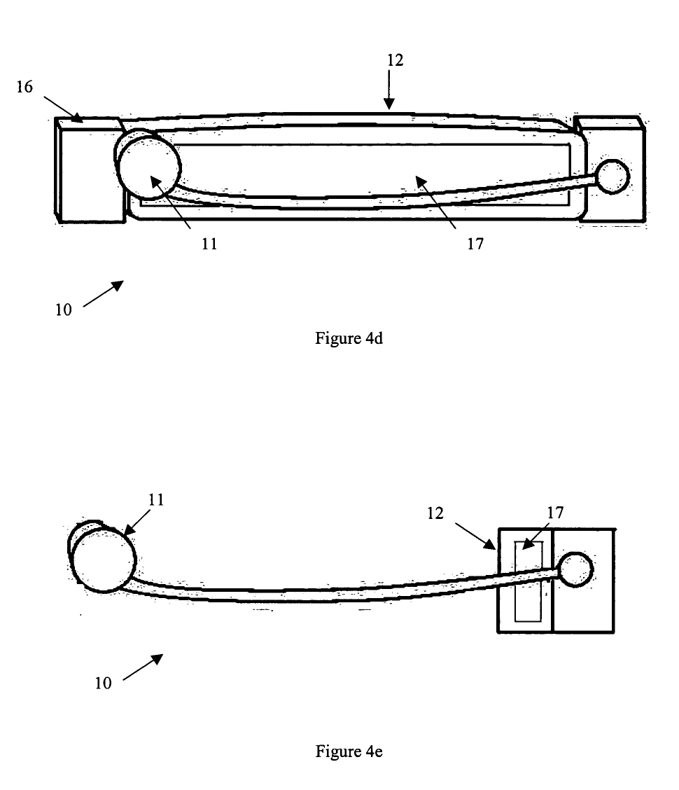

FIG. 4a is a pictorial representation of another embodiment of the device 10, which a user wears around his neck area. The device 10 includes three primary parts, namely a first module 11 in the exemplary form of a sensor 14, a second module 12 in the exemplary form of a processing unit 15 and a flexible (or semi-flexible) arm 13. The arm 13 may further includes a first arm 13a and a second arm 13b. In an example as illustrated in FIG. 4d, the second module 12 may further include a chamber 17 that houses the first arm 13a and the second arm 13b. Several mechanisms may be applied such that the first arm 13a and the second arm 13b are extendable from the second module 12. In one exemplary embodiment, the arms 13a and 13b may be retracted into the second module 12 by means of a wheel, coil or spring-based retraction device. For example, at a push of a button on the second module 12, the retraction device automatically collects the arms into the second module 12. The free end of the arm 13b may include a stopper 16 so that the end is captured in the second module 12. In another exemplary embodiment, the length of the arms 13a and 13b may be designed such that when the arms 13a and 13b are slide into the second module 12, they are housed within the second module 12 completely. It will be appreciated by one skilled in the art to modify the size of the first module 11, the second module 12 and the arm 13 so as to minimize the size of the device 10 accordingly.

FIG. 4b is a pictorial representation of the device 10. In the exemplary embodiment, the device 10 includes a first module 11 in the exemplary form of a sensor 14 and a processing unit 15, a second module 12, and an arm 13. As illustrated in FIG. 4b, the arm 13 may be designed in a coil-like or fan-like manner so that it can be easily folded and extended. FIG. 4c illustrates another exemplary embodiment of the device 10, wherein the second module 12 may include a chamber 17 that contains the arm 13. FIG. 4d is another pictorial representation of the device 10, wherein the arms are completely retracted within the chamber 17 of the second module 12.

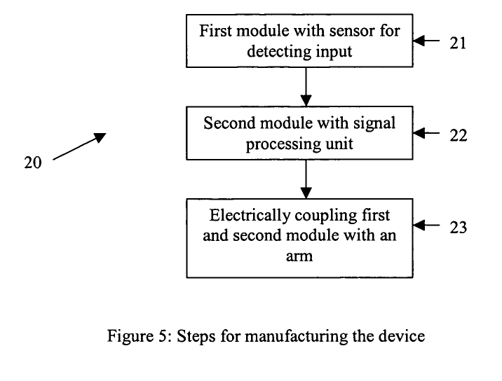

Now turning to FIG. 5, the block diagram illustrates the method 20 of manufacturing the device 10. The method 20 includes attaching a first module 11 in the exemplary form of a sensor 14 to a first end of an arm 13. Next, a second module 12 in the exemplary form of a signal-processing unit 15 is attached to a second end of the arm 13. In step 23, electrically coupling the first module and the second module 12 by the arm 13 for communication purposes, wherein the arm 13 is deformable so that the device 10 can be attached to a support.

It should be noted that this device may have various shapes, e.g., in order to prevent wind or other external interferences, and may be embedded or integrated in a variety of portable, wearable devices, e.g., a headset. In addition, the device may include other accessories, such as a clip or an attachment device, which allow the device to be attached to an object.

In another embodiment of the present invention, the device may work with standard GUIs' drivers, though special drivers, GUIs can be designed to match the invention's features, improve accuracy and take advantage of extra functionalities. Alternatively, the device may also receive input from the dialog boxes presented by many computer programs to specify settings (e.g., interaction range, meaning, control-display ratio, appearance, etc.) relating to the relevant program or to the computer system.

According to the exemplary embodiment of the present invention, the user “points and clicks”, e.g., moves a pointer or cursor, clicks, double-clicks, drags and drops icons and virtual objects, zooms, scrolls, etc., simply by breathing, puffing, biting a small device that may be positioned around the chin area with no direct contact with the mouth or skin.

In one embodiment, devices based on the technology may be wireless, functioning independent of the environment, which may be achieved by eliminating the need to upload drivers. The device may be a low power, energy saving device with an extended running time, possibly on the order of weeks. The device is intuitive, allowing for a slim learning curve. The device provides accuracy in control and provides fast action comparable to high-end mice. The device is adapted to avoid unwanted responses (e.g., due to wind, speech, etc.), and adapted to a variety of situations, contexts, and usage patterns.

The computer system may include a processor, a main memory and a static memory, which communicate with each other via a bus. The computer system may further include a video display unit (e.g., a liquid crystal display (LCD) or a cathode ray tube (CRT)). The computer system may also include an alphanumeric input device (e.g., a keyboard), a cursor control device (e.g., a mouse), a disk drive unit, a signal generation device (e.g., a speaker) and a network interface device. In alternative embodiments, the computer system may also comprise personal computer (PC), workstation, a set-top box (STB), Personal Digital Assistant (PDA), a cellular telephone, a web appliance or any machine capable of executing a sequence of instructions that specify actions to be taken by that machine.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A device to provide a pressure current input to a computer system, the device including:
a first module having a sensor, the sensor operationally to detect the pressure current input provided by a user and to convert the pressure current input into an electric signal;
a second module having a signal processing unit, the signal processing unit to process the electric signal; and
a flexible arm connecting the first module and the second module, the flexible arm being deformable to secure the device to a support and having at least a portion of sufficiently rigidity to support the first module in an input position to detect the pressure current input provided by the user.

2. The device of claim 1, wherein the pressure current input is a fluid current.

3. The device of claim 2, wherein the fluid current is an exhaled breath.

4. The device of claim 2, wherein the fluid current is an inhaled breath.

5. The device of claim 2, wherein the fluid current is in one or both of gaseous and liquid states.

6. The device of claim 1, wherein the pressure current input is a deformation force.

7. The device of claim 1, wherein the signal processing unit further includes a processor, a power unit and a wireless data transfer unit.

8. The device of claim 1, wherein the input position is proximal to a chin area of a user.

9. The device of claim 1, wherein the flexible arm includes a plurality of wires connecting the first module and the second module.

10. A device to provide a motion input to a computer system, the device including:
a first module having a sensor, the sensor operationally to detect the motion input provided by a user and to convert the motion input into an electric signal;
a second module having a signal processing unit, the signal processing unit to process the electric signal; and
a flexible arm member connecting the first module and the second module, the flexible arm member being deformable to secure the device to a support and having at least a portion of sufficiently rigidity to support the first module in an input position to detect the motion input provided by the user.

11. The device of claim 10, wherein the signal processing unit further includes a processor, a power unit and a wireless data transfer unit.

12. The device of claim 10, wherein the input position is proximal to a chin area of a user.

13. The device of claim 10, wherein the flexible arm includes a plurality of wires connecting the first module and the second module.

14. A device to provide a pressure current input to a computer system, the device including:
a first housing including at least one of a sensor and a signal processor; and
at least one arm coupled to and extendable relative to the housing so as to support the first housing relative to a support;
wherein the arm is deformable and has at least a portion of sufficiently rigidity to support the first housing in an input position to detect the pressure current input provided by the user.

15. The device of claim 14, wherein the pressure current input is a fluid current.

16. The device of claim 15, wherein the fluid current is an exhaled breath.

17. The device of claim 15, wherein the fluid current is an inhaled breath.

18. The device of claim 15, wherein the fluid current is in one or both of gaseous and liquid states.

19. The device of claim 14, wherein the pressure current input is a deformation force.

20. The device of claim 14, wherein the first housing defines a chamber to accommodate the arm.

21. The device of claim 14, wherein the arm is foldable relative to the first housing.

22. The device of claim 14, wherein the first housing includes the sensor.

23. The device of claim 22, wherein the first housing is coupled to a first end of the arm, a second housing is coupled to a second end of the arm and the second housing is to accomodate the signal processing unit.

24. The device of claim 23, wherein at least the first or the second housing defines a chamber to accommodate the arm.

25. The device of claim 24, wherein the arm is foldable relative to at least the first or the second housing.

26. The device of claim 14, wherein the input position is proximal to a chin area of a user.

27. A device to provide a motion input to a computer system, the device including:
a first housing including at least one of a sensor and a signal processor;
at least an arm coupled to and extendable relative to the housing so as to support the housing relative to a support; and
the arm being deformable and having at least a portion of sufficiently rigidity to support the first housing in an input position to detect the motion input provided by the user.

28. The device of claim 27, wherein the first housing defines a chamber to accommodate the arm.

29. The device of claim 27, wherein the arm is foldable relative to the housing.

30. The device of claim 27, wherein the first housing includes the sensor.

31. The device of claim 30, wherein the first housing coupled to a first end of the arm, a second housing coupled to a second end of the arm and the second housing to accommodate the signal processing unit.

32. The device of claim 31, wherein at least the first or the second housing defines a chamber to accommodate the arm.

33. The device of claim 32, wherein the arm is foldable relative to at least the first or the second housing.

34. The device of claim 27, wherein the input position is proximal to a chin area of a user.

35. A method of manufacturing a device to provide a pressure current input to a computer system including:
providing a first module having a sensor, the sensor detects the pressure current input and converts the pressure current input into an electric signal;
providing a second module having a signal processing unit, the signal processing unit processes the electric signal generated by the sensor; and
connecting a flexible member between the first and the second module, the flexible member being deformable to secure the device to a support and having at least a portion of sufficiently rigidity to support the first module in an input position to detect the pressure current input provided by the user.

36. A apparatus for providing a pressure current input to a computer system, the apparatus including:
first means for sensing the pressure current input and converting the pressure current input into an electric signal;
second means for processing the electric signal; and
third means for electrically connecting the first means and second means, wherein the third means includes means for securing the device to a support.
